(19) United States
(12) Patent Application Publication
(10) Pub. No.: US 2002/0132526 A1
(43) Pub. Date: Sep. 19, 2002

(54) Base cap for color cathode ray tube

(75) Inventors: Min-Cheol Bae, Kyungki-do (KR); Jong-Hoon Choi, Kyungki-do (KR); Woo-Seok Huh, Seoul (KR)

Correspondence Address: LEYDIG VOIT & MAYER, LTD, 700 THIRTEENTH ST. NW, SUITE 300, WASHINGTON, DC, 20005-3960, US

(73) Assignee: Samsung SDI Co., Ltd., Kyungki-do (KR)

(21) Appl. No.: 10/028,262

(22) Filed: Dec. 28, 2001

(30) Foreign Application Priority Data
Mar. 19, 2001 (KR) 2001-14049

(51) Int. Cl. H01J 1/00

(52) U.S. Cl. 439/618

(57) ABSTRACT

A base cap for a cathode ray tube (CRT) preventing insulation breakdown between a lead pin to which a high voltage is applied and a lead pin to which a comparatively low voltage is applied. Insulation breakdown due to poor application of a silicone composition between a stem of the CRT and a flange of the base cap is avoided. The base cap includes a cylindrical housing, a flange extending radially outward from the edge of the cylindrical housing and including holes into which lead pins fixed to the stem of an electron gun of the CRT are inserted; and at least one isolation element on the surface of the flange, facing the stem, for preventing breakdown of insulation between the lead pins.

### BACKGROUND OF THE INVENTION

1. Field of the Invention

The present invention relates to a cathode ray tube and, more particularly, to an improved base cap for a cathode ray tube, which is installed on the neck of the cathode ray tube in order to protect lead pins and prevent breakdown of insulation between the lead pins.

2. Description of the Related Art

As shown in FIG. 1, a conventional cathode ray tube (CRT) 10 includes a panel 12 on which a fluorescent film 11 is located, a funnel 13 attached to the panel 12, an electron gun 14 enclosed in a neck 13a of the funnel 13, and a deflection yoke 15 extending from the cone portion of the funnel 13 to the neck 13 a and deflecting an electron beam generated by the electron gun 14 to scan positions on the fluorescent film 11. The electron gun 14 is placed in the neck 13a of the CRT 10, to which a stem 17 including a plurality of lead pins 16 is fused. Voltages are applied to each of the electrodes of the electron gun 14 via the pins.

In the case of a CRT configured as described above, the lead pins 16 are installed all together at the edge of the neck 13a and thus are fragile. Given a slight shock, the edge of the neck may break or insulation between the lead pins 16 may be destroyed.

To solve this problem, in a conventional CRT a base cap is attached to the neck 13a of a CRT 10 so that the bases of the lead pins 16 and insulation between the lead pins 16 can be protected. Also, the lead pins 16 projecting from the base cap are protected by separating fins. Such an adapter and a base cap (or protector) for protecting lead pins is disclosed in U.S. Pat. No. 4,148,541.

Referring to FIG. 2, a base cap 20 includes a cylindrical main frame 21, a flange 22 which extends radially from the main frame 21 and including holes 22a into which the lead pins 16 may be inserted. The holes encircle the main frame 21. A blocking wall 23 on the circumferential surface of the main frame 21 encloses lead pins to which a high voltage is applied.

Another base for protecting lead pins has been disclosed in U.S. Pat. No. 4,127,313. That base, which extends radially from an open edge of a housing, has a recess on its rear surface and includes a flange having holes arranged in a circle and into which lead pins are inserted. Separating fins extend between the lead pins on the outer circumferential surface of the housing.

As described above, insulation between lead pins projecting from the flange can be improved through the base cap or base, but flow of a leakage current, which flows along the surface of the stem of the electron gun, where lead pins are disposed, is difficult to prevent. In particular, as cathode ray tubes are made flatter with a larger screen area, the deflection angle at which an electron beam is deflected by the deflection yoke 15, becomes bigger. As a result, the voltage applied to electrodes to form the lens of an electron gun, e.g., dynamic focus voltage for forming a quadrupole lens, is increased compared to a static voltage. For this reason, although the base cap 20 is attached to the edge of the neck 13a, insulation between lead pins may break down due to a voltage difference between a lead pin to which a dynamic voltage is applied, and a lead pin to which a static voltage is applied. Further, in the case of a conventional CRT, a silicone composition has been applied between the stem of an electron gun and a base cap so that the insulation between lead pins is strengthened. Nonetheless, the insulation may deteriorate due to poor application of or blowholes in the silicone composition.

### SUMMARY OF THE INVENTION

To solve the above problems, it is an objective of the present invention to provide a base cap for a cathode ray tube (CRT) that prevents breakdown of insulation between a lead pin to which a high voltage is applied and a lead pin to which a low voltage is applied due to flow of a leakage current along the surface of a stem.

Accordingly, in order to achieve the above objective, a base cap for a cathode ray tube includes a cylindrical housing; a flange extending radially outwardly from the cylindrical housing and having a generally planar surface including a plurality of holes, the surface facing a stem of an electron gun when the base cap is mounted on the stem with lead pins fixed to the stem inserted into the plurality of holes; and at least one isolation element projecting relative to the surface of the flange, proximate at least a first of the holes, for preventing insulation breakdown between lead pins inserted into the first hole and a second hole adjacent the first hole.

The isolation element according to the present invention may be a projection between holes for lead pins on the surface of the flange facing the stem, a dam on the rear surface of the flange surrounding one of the holes, or a recess in the rear surface at a hole receiving a lead pin to which a high voltage is applied. Preferably, the projection, dam, or recess includes a sloping surface, oblique to the surface of the flange, for urging a silicone composition, disposed between the base cap and the stem, into a hole adjacent the projection, surrounded by a dam, or including a recess.

### BRIEF DESCRIPTION OF THE DRAWINGS

FIG. 1 is a partially cut-away perspective view of a conventional CRT;

FIG. 2 is a perspective view illustrating a base cap for a conventional CRT;

FIG. 3 is a perspective view illustrating a base cap for a CRT according to the present invention; and

FIGS. 4A, 5A, 6 and 7 are perspective views illustrating different embodiments of a base cap for a CRT according to the present invention and FIGS. 4B and 5B are detail views of FIGS. 4A and 5A, respectively.

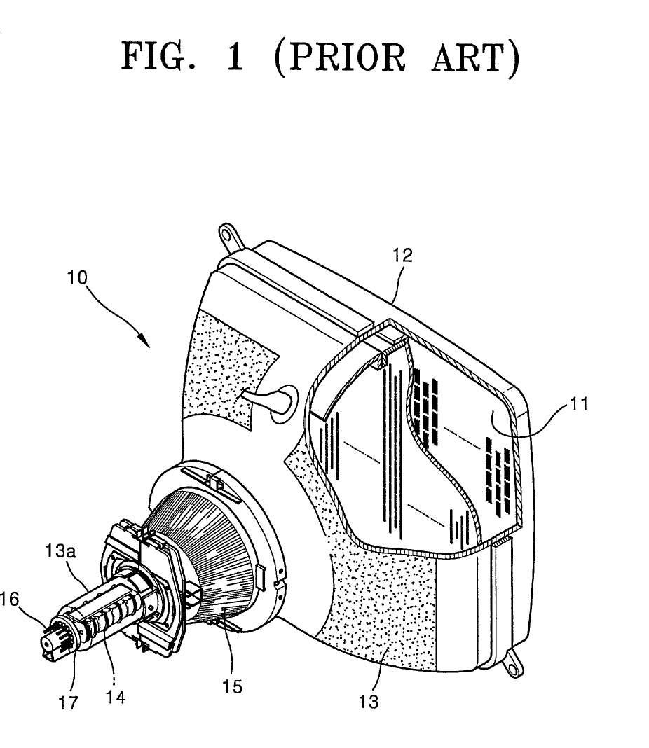

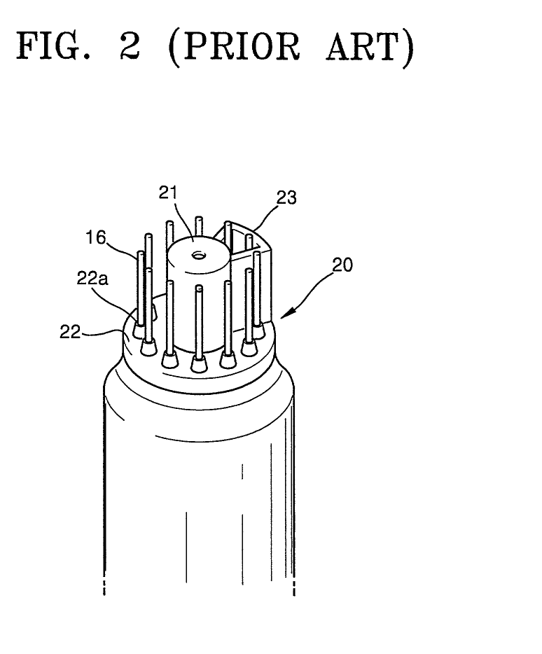

### DETAILED DESCRIPTION OF THE INVENTION

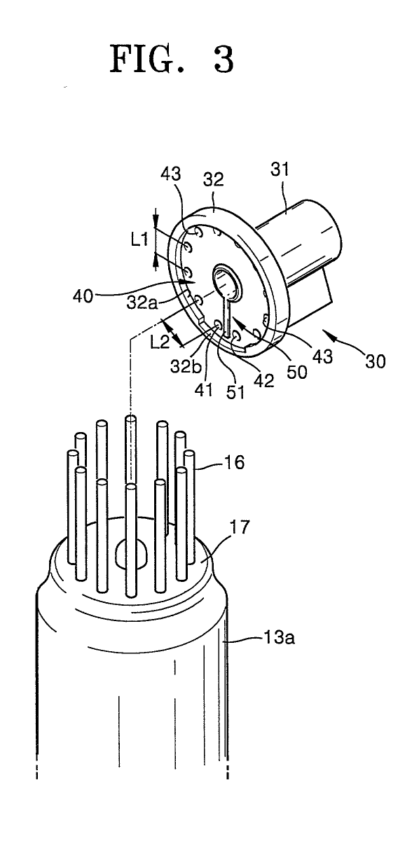

A base cap for a color CRT according to the present invention is combined with a stem of an electron gun in a neck of a CRT. Lead pins attached to the stem are used to apply electric potentials to electrodes of the electron gun. In FIG. 3, an embodiment of the base cap for a CRT according to the invention is illustrated.

As shown in FIG. 3, a base cap 30 includes a cylindrical housing 31 and a flange 32 that extends radially outward from the housing 31. Along the edge of the flange 32, holes 40, which include first, second, and third holes 41, 42, and 43, and are alignable with the lead pins 16, are located. The separation between the first hole 41, into which a lead pin to which a high voltage is applied is inserted, and the third hole 43, into which a lead pin to which a low voltage is applied, is inserted is kept at L2, which is longer than the separation L1 between the two adjacent third holes 43. The flange has a rear surface that faces the stem of a CRT on which the base cap is mounted. A peripheral rim 32a of the flange 32 surrounds the edge of and projects, relative to the rear surface of the flange 32, toward a CRT on which the base cap is mounted. As a result, an area where the holes 41 and 42 are located is recessed. An arcuate section 32b of the rim 32a, thinner than other parts of the rim 32a, is located near the first and second holes 41 and 42, thus providing a greater distance between the rim 32a and the first and second holes 41 and 42.

An isolation element, which prevents breakdown of the insulation between lead pins due to a voltage difference, is located on the rear surface of the flange 32. In the embodiment of FIG. 3, the isolation element is located between the first hole 41, into which a lead pin for applying a dynamic focus voltage is inserted, and the second hole 42, into which a lead pin for applying a static voltage is inserted. In the embodiment of FIG. 3, the isolation element 50 includes a linear projection 51 projecting outwardly from the rear surface of the flange 32 between the first and second holes 41 and 42, as shown in FIG. 3. It is preferable that the projection 51 have the same height relative to the rear surface of the flange as the rim 32a.

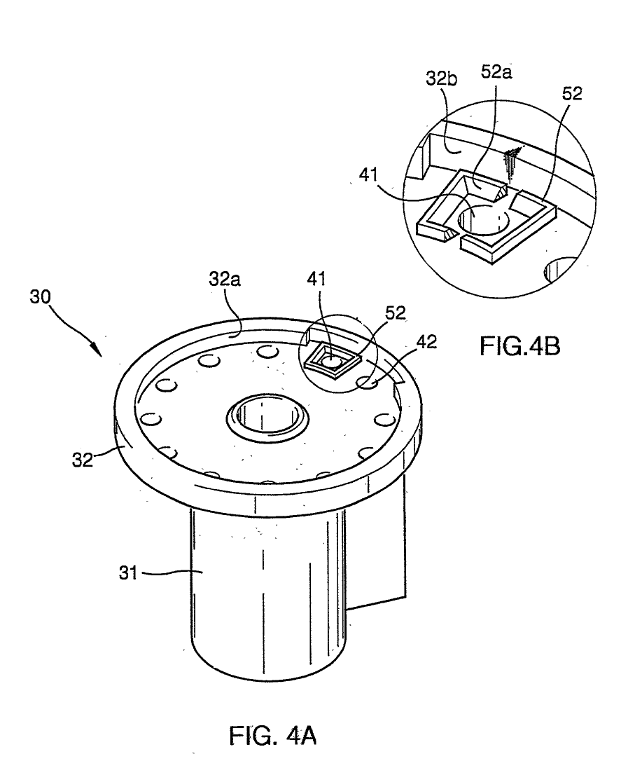

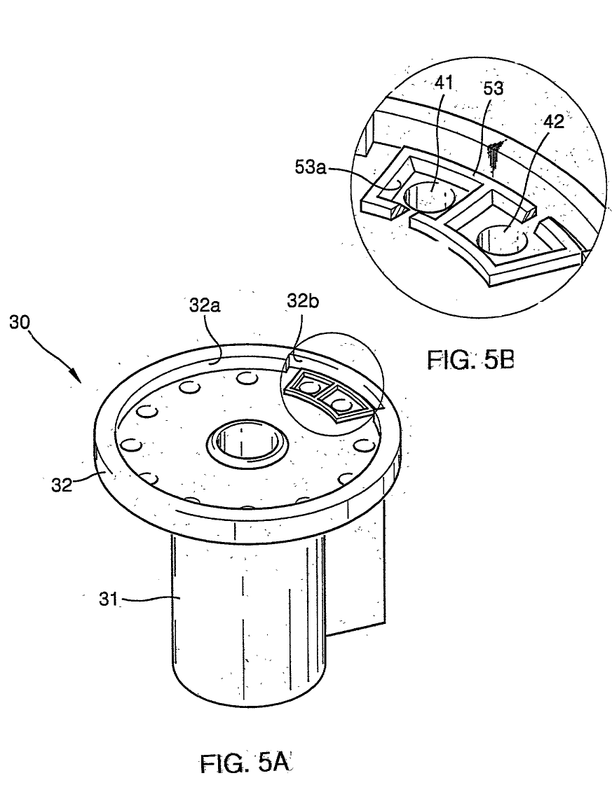

In another embodiment of the present invention, the isolation element is a dam 52 having a wall that projects outward from the rear surface of the flange and surrounds the first hole 41 into which a lead pin to which a high voltage is applied is inserted, as shown in FIGS. 4A and 4B. FIG. 4B is partially sectioned detail view for illustrating the dam clearly. In yet another embodiment, the dam may be a sill that isolates and separately surrounds the first and second holes 41 and 42, as shown in FIGS. 5A and 5B. Preferably, the sill includes a common wall between the first and second holes 41 and 42. FIG. 5B, like FIG. 4B, is a partially sectioned detail view showing the wall of the dam more clearly. It is preferable that an inner surface 52a of the dam 52 shown in FIG. 4B and the inner surface 53a of the sill 53 shown in FIG. 5B be oblique to the rear surface of the flange and slope toward the centers of the first and second holes 41 and 42, respectively, so that the silicone composition can be applied evenly to the deepest part of the dam 52 or the sill 53 without a gap, when the silicone composition is applied between the flange 32 and the stem 17.

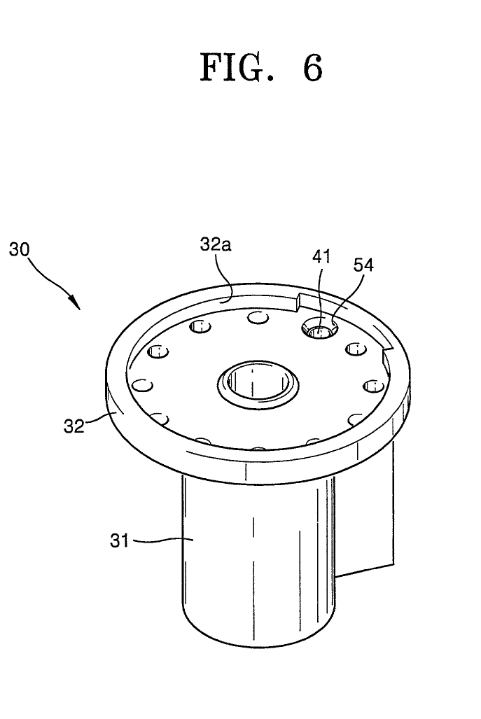

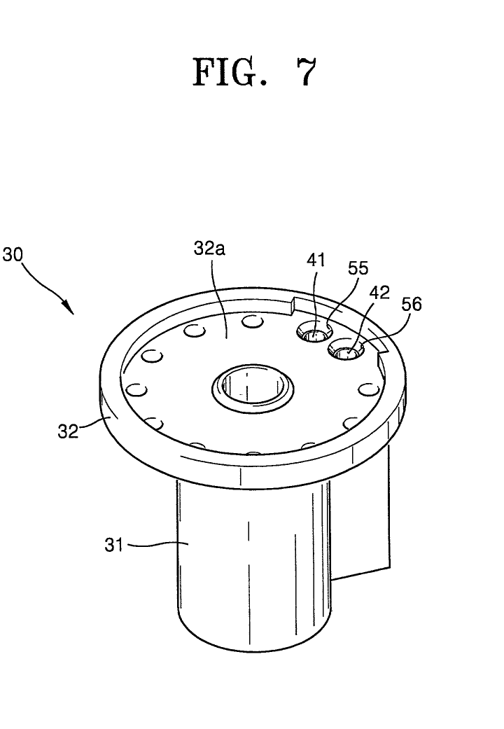

Referring to FIG. 6, showing another embodiment of the present invention, the isolation element is a recess 54 projecting inwardly into the surface of the flange and surrounding the first hole 41. The recess 54 is tapered from a larger opening in the rear surface of the flange, with a chamfered wall tapering to the diameter of the first hole 41. In yet another embodiment, the isolation element includes recesses in the rear surface of the flange surrounding each of the first hole 41 and the second hole 42, as shown in FIG. 7.

The isolation element for a color CRT according to the present invention is not limited to the described embodiments and can have various configurations, provided that breakdown of insulation between lead pins inserted in the first and second holes 41 and 42 and to which a high voltage and a comparatively low voltage are respectively applied is prevented.

Next, the operation of the base cap for a CRT according to the present invention that is configured as described above will be described with reference to the drawings. The base cap 30 is combined with the stem 17, so that the lead pins 16 on the stem 17 are inserted into the holes 40 in the flange 32. The silicone composition is applied on the rear surface of the flange 32 of the base cap 30 and the surface of the stem 17, so that insulation between the lead pins 16 is strengthened and the base cap 30 is fixed to the stem 17.

Once the stem 17 is combined with the base cap 30, the distance along surfaces between the lead pins becomes comparatively longer. As a result, insulation between the lead pins is prevented from breaking down, even though there is a large voltage difference between a lead pin to which a high voltage is applied and a lead pin to which a comparatively low voltage is applied. Especially, if the silicone composition (not shown) is applied between the stem 17 and the flange 32, the projection 51 on the flange 32 is buried in the applied silicone composition and thereby the insulation is enhanced (refer to FIG. 3). The inner flanks of the projection 52a and 53a are sloped and thus the applied silicone composition is concentrated and urged toward the first and second holes 41 and 42 (refer to FIGS. 4A and 5A).

As shown in FIG. 6, when the recess 54 surrounds the first hole 41, the distance along the surfaces between the lead pins becomes longer due to the deviation of the recess 54 from the surface of the flange 32, so that insulation breakdown is reduced. Further, the silicone composition applied to the flange 32 and/or the stem 17 collects in the recess 54 surrounding the hole, so that the insulation effect is increased. This effect also occurs for the embodiment of the base cap shown in FIG. 7.

As described, the base cap for a CRT according to the present invention has advantages in that insulation breakdown between a lead pin to which a high voltage is applied to form a quadrupole lens, and a lead pin to which a comparatively low voltage is applied is prevented. Further, insulation breakdown, due to poor application of the silicone composition and poor adhesion of the silicone composition, is eliminated by the oblique surfaces of the isolation element.

While the present invention has been particularly shown and described with reference to the preferred embodiments thereof, the present invention is not restricted to the above embodiments. It will be understood by those skilled in the art that various changes in form and details may be made to the described embodiments without departing from the spirit and scope of the invention as defined by the appended claims.

What is claimed is:

1. A base cap for a cathode ray tube, the base cap comprising:
a cylindrical housing;
a flange extending radially outwardly from the cylindrical housing and having a generally planar surface including a plurality of holes, the surface facing a stem of an electron gun when the base cap is mounted on the stem with lead pins fixed to the stem inserted into the plurality of holes; and
at least one isolation element projecting relative to the surface of the flange, proximate at least a first of the holes, for preventing insulation breakdown between lead pins inserted into the first hole and a second hole adjacent the first hole.

2. The base cap as claimed in claim 1, wherein the isolation element is a projection extending outwardly from the surface and located between the first and second holes.

3. The base cap as claimed in claim 2, wherein the flange includes a peripheral rim projecting relative to the surface and having a height relative to the surface, and the projection projects relative to the surface by substantially the height.

4. The base cap as claimed in claim 1, wherein the isolation element is a first recess projecting into the surface and surrounding the first hole.

5. The base cap as claimed in claim 4, wherein the first recess includes an inner wall oblique to the surface.

6. The base cap as claimed in claim 4, wherein the isolation element includes a second recess extending into the surface and surrounding the second hole.

7. The base cap as claimed in claim 6, wherein the first and second recesses include inner walls oblique to the surface.

8. The base cap as claimed in claim 1, wherein the isolation element includes a dam projecting from the surface and surrounding the first hole.

9. The base cap as claimed in claim 8, wherein the dam includes an inner wall oblique to the surface and sloping toward the first hole.

10. The base cap as claimed in claim 8, wherein the dam encloses a generally rectangular area on the surface.

11. The base cap as claimed in claim 8, wherein the dam substantially surrounds the second hole.

12. The base cap as claimed in claim 11, wherein the dam includes respective inner walls oblique to the surface and sloping toward the first and second holes.

13. The base cap as claimed in claim 11, wherein the dam encloses two contiguous generally rectangular areas on the surface.

14. The base cap as claimed in claim 1, wherein the flange includes a peripheral rim projecting relative to the surface.

15. The base cap as claimed in claim 14, wherein the rim includes an arcuate section proximate the first and second holes and thinner than other parts of the rim.
